(19) United States
(12) Patent Application Publication
(10) Pub. No.: US 2026/0091762 A1
(43) Pub. Date: Apr. 2, 2026

(54) BLADE UNIT, HEATER MODULE, AND WASHER FLUID SUPPLY APPARATUS INCLUDING THE SAME

(71) Applicant: SL Corporation, Daegu (KR)

(72) Inventors: Hong Jun Cha, Daegu (KR); Seong Guk Bae, Daegu (KR)

(21) Appl. No.: 19/341,090

(22) Filed: Sep. 26, 2025

(30) Foreign Application Priority Data
Sep. 27, 2024 (KR) 10-2024-0131981

(51) Int. Cl. B60S 1/48; F24H 9/00

(52) U.S. Cl. CPC B60S 1/488; F24H 9/0021; F24H 2250/04

(57) ABSTRACT

Provided is a heater module including a heater, a blade unit including an accommodating part configured to accommodate the heater therein, a first blade part disposed at one side of the accommodating part, and a second blade part disposed at another side of the accommodating part, and a body unit coupled to one side of the blade unit, wherein the first blade part and the second blade part have different blade structures.

### CROSS-REFERENCE TO RELATED APPLICATION

This application is based on and claims priority under 35 U.S.C. § 119 to Korean Patent Application No. 10-2024-0131981, filed on Sep. 27, 2024, in the Korean Intellectual Property Office, the disclosure of which is incorporated by reference herein in its entirety.

### BACKGROUND

### 1. Field

Embodiments of the present disclosure relate to a blade unit, a heater module, and a washer fluid supply apparatus including the same.

### 2. Description of the Related Art

In general, when a driver's forward visibility is hindered while driving due to the adhesion of foreign substances such as dust to a windshield of a vehicle, a driver may spray washer fluid onto the windshield and simultaneously operate a wiper to remove the foreign substances, thereby keeping the windshield clean.

Meanwhile, although an increasing number of vehicles are being equipped with various sensors, when contaminants adhere to or accumulate on sensor surfaces under road conditions such as snow or rain, the sensors may not operate properly, and thus cleaning the sensors using washer fluid becomes necessary.

In regions where the temperature drops below freezing or during the winter season, the washer fluid may remain in a cold state due to low ambient temperatures and fail to fully perform its intended function, and when the temperature drops significantly, the washer fluid may freeze and become unusable.

To address these issues, an apparatus for heating washer fluid is being provided in a reservoir tank that stores the washer fluid.

### SUMMARY OF THE INVENTION

The present disclosure is directed to providing a blade unit configured to efficiently supply washer fluid to a washer pump through a blade structure, and a heater module and a washer fluid supply apparatus including the same.

However, these objects are only examples and the scope of the present disclosure is not limited thereby.

According to an aspect of the present disclosure, there is provided a heater module including a heater, a blade unit including an accommodating part configured to accommodate the heater therein, a first blade part disposed at one side of the accommodating part, and a second blade part disposed at another side of the accommodating part, and a body unit coupled to one side of the blade unit, wherein the first blade part and the second blade part have different blade structures.

In an embodiment of the present disclosure, the first blade part may include a first blade connected to the accommodating part, and a pair of second blades symmetrically disposed with respect to the first blade.

In an embodiment of the present disclosure, the pair of second blades may not be directly connected to the accommodating part.

In an embodiment of the present disclosure, each of the pair of second blades may include a second-1 sub-blade, a second-2 sub-blade, and a second-3 sub-blade that extend in different directions from each other.

In an embodiment of the present disclosure, the second-1 sub-blade may extend in a same direction as a direction in which the first blade extends, and the second-2 sub-blade and the second-3 sub-blade may extend in directions different from the direction in which the first blade extends.

In an embodiment of the present disclosure, an angle between the second-1 sub-blade and the second-2 sub-blade may be smaller than an angle between the second-1 sub-blade and the second-3 sub-blade.

In an embodiment of the present disclosure, an angle between the first blade and the second-2 sub-blade may be greater than an angle between the first blade and the second-3 sub-blade.

In an embodiment of the present disclosure, the second blade part may include third blades that are connected to the accommodating part and are disposed to be spaced apart from each other.

In an embodiment of the present disclosure, the third blades may be disposed to be spaced apart from each other at equal intervals.

In an embodiment of the present disclosure, one of the third blades may be disposed on a same plane as the first blade.

In an embodiment of the present disclosure, the blade unit may further include a connection part configured to connect one side of each of the first blade part, the accommodating part, and the second blade part to each other and to be coupled to the body unit.

In an embodiment of the present disclosure, the heater module may further include a sealing unit disposed at one side of the body unit.

According to an aspect of the present disclosure, there is provided a washer fluid supply apparatus including a washer fluid reservoir, a heater module disposed in the washer fluid reservoir, and a washer pump connected to one side of the washer fluid reservoir, wherein the heater module includes a heater, a blade unit including an accommodating part configured to accommodate the heater therein, a first blade part disposed at one side of the accommodating part, and a second blade part disposed at another side of the accommodating part, and a body unit coupled to one side of the blade unit, wherein the first blade part and the second blade part have different blade structures.

In an embodiment of the present disclosure, the first blade part may be disposed on an upper side with respect to a direction of gravity in the washer fluid reservoir, and the second blade part may be disposed on a lower side with respect to the direction of gravity in the washer fluid reservoir.

According to an aspect of the present disclosure, there is provided a blade unit including an accommodating part configured to accommodate a heater therein, a first blade part disposed on one side of the accommodating part, and a second blade part disposed on another side of the accommodating part.

In an embodiment of the present disclosure, the first blade part may include a first blade connected to the accommodating part, and a pair of second blades symmetrically disposed with respect to the first blade.

In an embodiment of the present disclosure, each of the pair of second blades may include a second-1 sub-blade, a second-2 sub-blade, and a second-3 sub-blade that extend in different directions from each other.

In an embodiment of the present disclosure, the second-1 sub-blade may extend in a same direction as a direction in which the first blade extends, and the second-2 sub-blade and the second-3 sub-blade may extend in directions different from the direction in which the first blade extends.

In an embodiment of the present disclosure, an angle between the second-1 sub-blade and the second-2 sub-blade may be smaller than an angle between the second-1 sub-blade and the second-3 sub-blade.

In an embodiment of the present disclosure, an angle between the first blade and the second-2 sub-blade may be greater than an angle between the first blade and the second-3 sub-blade.

Other aspects, features, and advantages other than those described above will become apparent from the following drawings, claims, and detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings.

FIG. 1 is a view illustrating a state in which a washer fluid supply apparatus according to an embodiment of the present disclosure is mounted in a vehicle.

FIG. 2 is a cross-sectional view illustrating only the washer fluid supply apparatus of FIG. 1.

FIG. 3 is a perspective view illustrating a heater module according to an embodiment of the present disclosure.

FIG. 4 is an exploded view of the heater module of FIG. 3, showing a partial configuration thereof in a disassembled state.

FIG. 5, FIG. 6, and FIG. 7 are views for describing a blade unit of FIG. 3.

### DETAILED DESCRIPTION

Hereinafter, embodiments will be described below in detail with reference to the accompanying drawings, and when the embodiments of the present disclosure are described with reference to the drawings, the same or corresponding components are given the same reference numerals, and repetitive descriptions thereof will be omitted.

As the present embodiments allow for various modifications, particular embodiments will be illustrated in the drawings and further described in the detailed description. The effects and features of the present embodiments and the accompanying methods thereof will become apparent from the following description of the contents, taken in conjunction with the accompanying drawings. However, the present embodiments are not limited to the embodiments described below, and may be implemented in various forms.

In order to clearly describe the present disclosure in the drawings, parts which are not related to the description have been omitted, and like reference numerals refer to similar parts throughout the specification.

As used herein, an expression used in the singular encompasses the expression of the plural, unless it has a clearly different meaning in the context.

It will be further understood that the terms “comprises” and/or “comprising” used herein specify the presence of stated features or components, but do not preclude the presence or addition of one or more other features or components.

In the following embodiments, when a unit, region, or component is referred to as being “formed on” another unit, region, or component, it can be directly or indirectly formed on the other unit, region, or component. That is, for example, intervening units, regions, or components may be present.

In the following embodiments, terms such as “connecting” or “coupling” two members do not necessarily mean a direct and/or fixed connection or coupling of the two members, unless the context clearly indicates otherwise, and do not preclude another members from being interposed between the two members.

Sizes of components in the drawings may be exaggerated or reduced for convenience of description. For example, since the size and thickness of each component shown in the drawings are arbitrarily indicated for convenience of description, the following embodiment is not necessarily limited to what is illustrated.

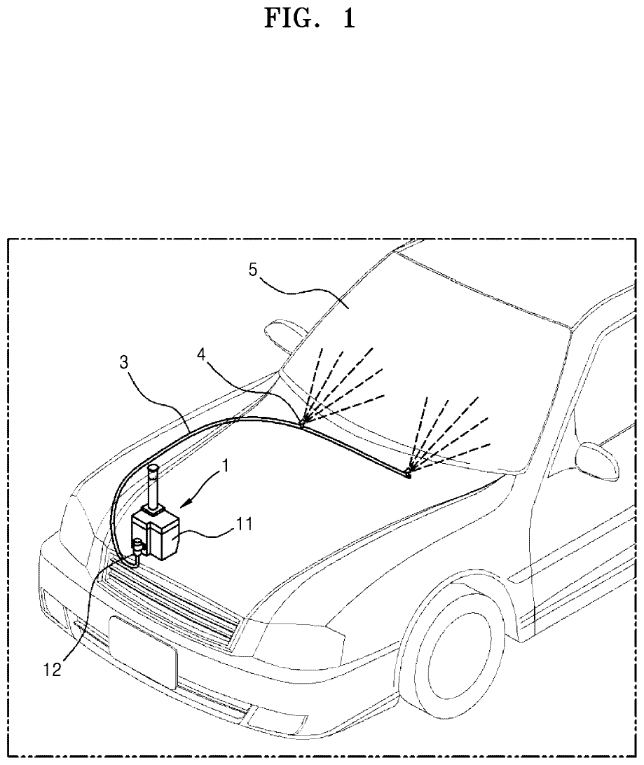

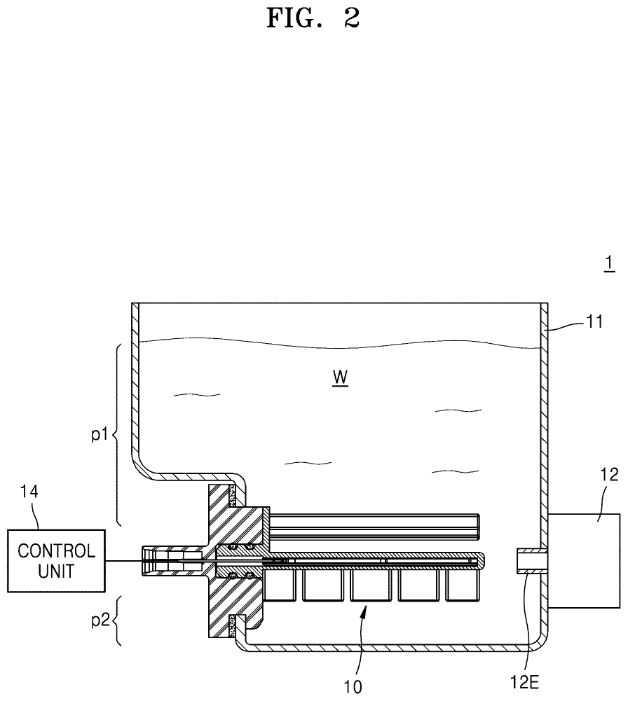

FIG. 1 is a view illustrating a state in which a washer fluid supply apparatus according to an embodiment of the present disclosure is mounted in a vehicle, and FIG. 2 is a cross-sectional view illustrating only the washer fluid supply apparatus of FIG. 1.

Referring to FIGS. 1 and 2, a washer fluid supply apparatus 1 according to an embodiment of the present disclosure may include a washer fluid reservoir 11, a heater module 10, and a washer pump 12.

The washer fluid supply apparatus 1 is configured such that the washer pump 12 pressurizes washer fluid w stored in the washer fluid reservoir 11 and sprays the washer fluid onto a glass surface through a spray nozzle 4. The spray nozzle 4 may be installed inside a cowl top or on a hood of a vehicle.

When a driver turns on an operation switch, the washer pump 12 operates to pressurize the washer fluid w stored in the washer fluid reservoir 11, and the pressurized washer fluid w is sprayed onto a glass 5 through the spray nozzle 4. In cold regions or under low-temperature conditions, the washer fluid w may freeze, and as the temperature decreases, the viscosity of the washer fluid increases, which may result in washer fluid spray failure.

To address this issue, a conventional washer fluid supply apparatus is provided with a heater to melt frozen washer fluid, but due to convection generated by the heater, it has been difficult to efficiently supply the washer fluid to the washer pump 12 located at a lower portion of the washer fluid supply apparatus.

In the washer fluid supply apparatus 1 according to an embodiment of the present disclosure, washer fluid can be effectively supplied to the washer pump 12 located at a lower portion of the washer fluid reservoir 11 by modifying a blade structure.

The washer fluid reservoir 11 may accommodate the washer fluid w therein.

The washer pump 12 may be connected to one side of the washer fluid reservoir 11. The washer pump 12 may be disposed at one side of the lower portion of the washer fluid reservoir 11 and may apply a discharge pressure to discharge the washer fluid w. The washer pump 12 may include a pump inlet 12E that extends through the washer fluid reservoir 11 and is disposed to face the washer fluid w.

The heater module 10 may be disposed inside the washer fluid reservoir 11. For example, the heater module 10 may be disposed inside the washer fluid reservoir 11 and at the lower portion thereof with respect to the direction of gravity. One end of the heater module 10 may be disposed to face the pump inlet 12E.

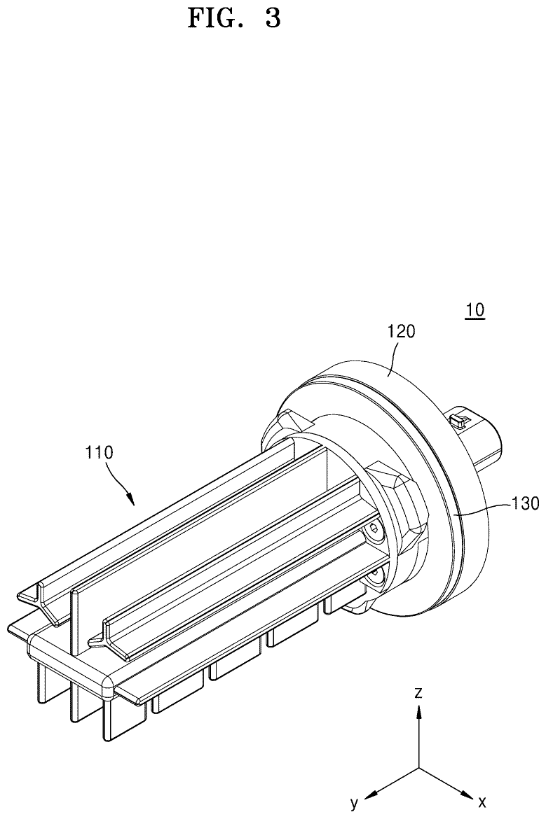

The heater module 10 may be coupled to and disposed in the washer fluid reservoir 11. As illustrated in the drawing, a blade unit 110 (see FIG. 3) of the heater module 10 may be directly exposed to the washer fluid w. However, the present disclosure is not limited thereto, and in another embodiment, the heater module 10 may include a separate cover (not shown) so that the washer fluid w is introduced into the cover, heated therein, and transferred to the pump inlet 12E.

The washer fluid supply apparatus 1 may further include a control unit 14 configured to control the operation of the heater module 10. The control unit 14 may receive information from an internal sensor (not shown) configured to measure the temperature of the washer fluid and an external sensor (not shown) configured to measure the temperature of outside air, and may control a driving time and driving temperature of the heater module 10, more specifically, a heater 100, based on the measured temperatures. However, the present disclosure is not limited thereto, and the heater module 10 may also be operated manually by a user.

In an embodiment, although not illustrated in the drawing, the washer fluid supply apparatus 1 may further include a level sensor (not shown) configured to measure a fluid level in the washer fluid reservoir 11.

Hereinafter, the heater module 10 and the blade unit 110 will be described in detail.

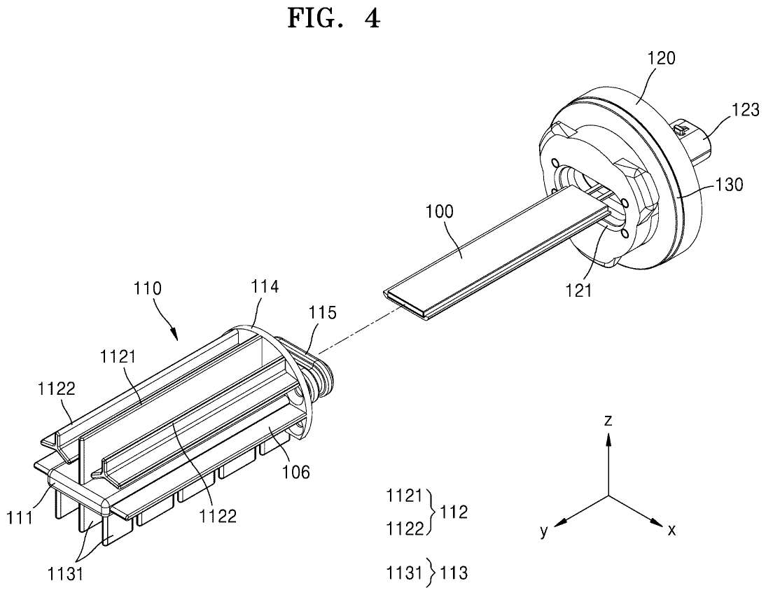

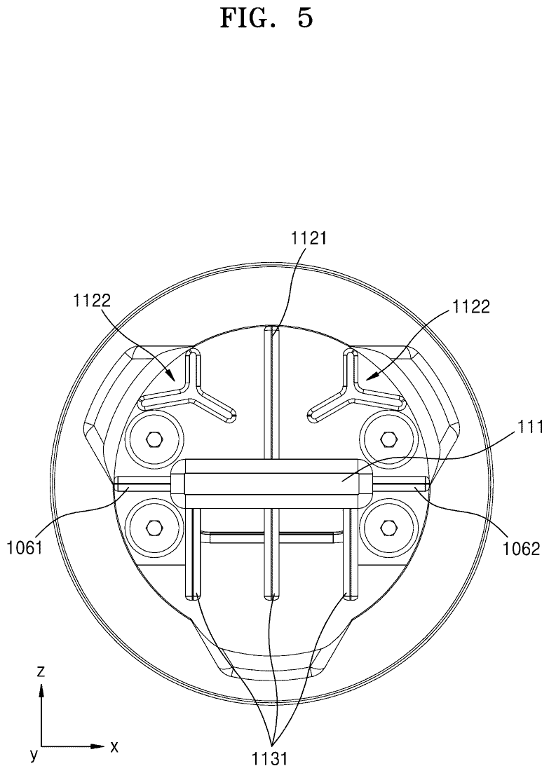

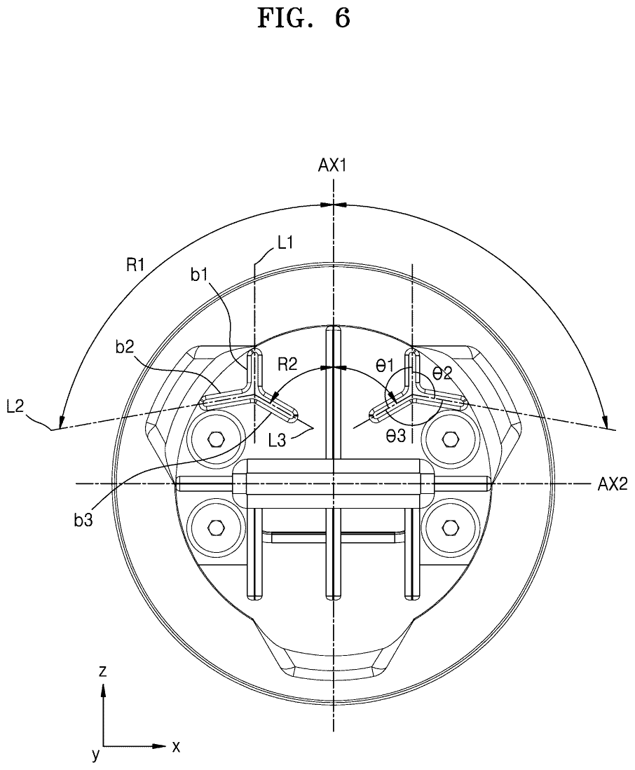

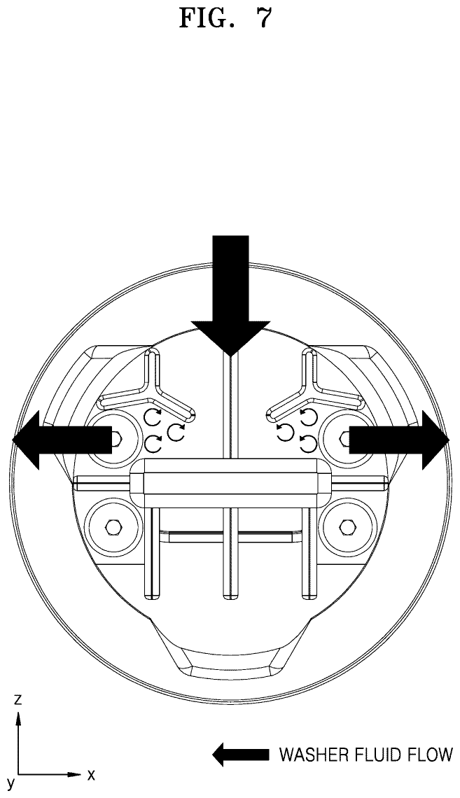

FIG. 3 is a perspective view illustrating the heater module 10 according to an embodiment of the present disclosure, and FIG. 4 is an exploded view of the heater module 10 of FIG. 3, showing a partial configuration thereof in a disassembled state. FIGS. 5 to 7 are views for describing the blade unit 110 of FIG. 3.

Referring to FIGS. 3 to 7, the heater module 10 according to an embodiment of the present disclosure includes the heater 100, the blade unit 110, and a body unit 120. In an embodiment, the heater module 10 may further include a sealing unit 130.

The heater 100 serves as a heat-generating source of the heater module 10 and generates heat upon application of electric current. The heater 100 may be implemented as a positive temperature coefficient (PTC) heater, which is composed of a thermistor whose resistance increases gradually as the temperature rises, and then increases rapidly once a specific temperature is reached. That is, when an appropriate voltage is applied, the heater 100 may exhibit a self-regulating function based on ambient temperature and heat dissipation conditions, and may maintain a constant temperature without a separate controller. A heating element of the PTC heater may include a material having BaTiO₃ as a base composition, with additives such as La, Nb, Sr, Pb, or Mn, or may be a Zn—Ti—Ni—O-based ceramic.

The blade unit 110 may include an accommodating part 111 configured to accommodate the heater 100 therein, a first blade part 112 disposed on one side of the accommodating part 111, and a second blade part 113 disposed on another side of the accommodating part 111.

The blade unit 110 may include a thermally conductive material and may serve to transfer heat generated from the heater 100.

The accommodating part 111 may include an accommodating space configured to accommodate the above-described heater 100 therein. The accommodating part 111 may be formed in a shape corresponding to the shape of the heater 100. The accommodating part 111 may have a length extending in a longitudinal direction of the blade unit 110 (y-direction). In an embodiment, the accommodating part 111 may have a predetermined width in a direction (x-direction) intersecting the longitudinal direction of the blade unit 110 (y-direction).

The first blade part 112 may be disposed on one side of the accommodating part 111, and the second blade part 113 may be disposed on another side of the accommodating part 111. Here, the first blade part 112 and the second blade part 113 may have different blade structures.

For example, the first blade part 112 may include a first blade 1121 and a pair of second blades 1122.

The first blade 1121 may be connected to the accommodating part 111. The first blade 1121 may be disposed along an imaginary first extension line AX1 that passes through the accommodating part 111. One side of the first blade 1121 may be directly coupled to the accommodating part 111, and another side thereof may extend in a direction toward an outer edge of the blade unit 110. For example, as illustrated in FIG. 4, the first blade 1121 may have an elongated rectangular shape extending in the longitudinal direction of the blade unit 110 (y-direction).

The pair of second blades 1122 may be symmetrically disposed with respect to the first blade 1121. In this case, the pair of second blades 1122 may not be directly connected to the accommodating part 111. As will be described below, the pair of second blades 1122 may be fixed at one end via a connection part 114 and may be disposed in a state of being spaced a predetermined distance apart from the accommodating part 111.

Each of the pair of second blades 1122 may include a second-1 sub-blade b1, a second-2 sub-blade b2, and a second-3 sub-blade b3 that extend in different directions. The second-1 sub-blade b1, the second-2 sub-blade b2, and the second-3 sub-blade b3 may extend in respective different directions from a center of the second blade 1122.

At this time, the second-1 sub-blade b1 may extend in the same direction as the first blade 1121. In other words, an imaginary first line L1 extending along the second-1 sub-blade b1 may be parallel to the imaginary first extension line AX1 passing through the first blade 1121.

The second-2 sub-blade b2 and the second-3 sub-blade b3 may extend in directions different from the direction in which the first blade 1121 extends. In other words, an imaginary second line L2 extending along the second-2 sub-blade b2 may intersect the imaginary first extension line AX1 passing through the first blade 1121. An imaginary third line L3 extending along the second-3 sub-blade b3 may intersect the imaginary first extension line AX1 passing through the first blade 1121.

The second-2 sub-blade b2 may be inclined at a first angle R1 with respect to the first blade 1121. The second-3 sub-blade b3 may be inclined at a second angle R2 with respect to the first blade 1121. The first angle R1 between the first blade 1121 and the second-2 sub-blade b2 may be greater than the second angle R2 between the first blade 1121 and the second-3 sub-blade b3.

With the above-described structure, inter-blade angles may be formed between the second-1 sub-blade b1, the second-2 sub-blade b2, and the second-3 sub-blade b3. A first inter-blade angle θ2 may be formed between the second-1 sub-blade b1 and the second-2 sub-blade b2, a second inter-blade angle θ1 may be formed between the second-1 sub-blade b1 and the second-3 sub-blade b3, and a third inter-blade angle θ3 may be formed between the second-2 sub-blade b2 and the second-3 sub-blade b3.

The first inter-blade angle θ2 between the second-1 sub-blade b1 and the second-2 sub-blade b2 may be smaller than the second inter-blade angle θ1 between the second-1 sub-blade b1 and the second-3 sub-blade b3.

In an embodiment, the second-3 sub-blades b3 of the pair of second blades 1122 may be disposed to face each other with respect to the first blade 1121. In this case, the second-3 sub-blades b3 may serve to guide the washer fluid from the upper side to the accommodating part 111 by being disposed to be inclined toward the accommodating part 111. For example, the inter-blade angle θ1 between the second-1 sub-blade b1 and the second-3 sub-blade b3 may be greater than 90°.

The second-2 sub-blades b2 of the pair of second blades 1122 may be disposed to face outward from the blade unit 110. Accordingly, as shown in FIG. 7, the pair of second blades 1122 may guide the washer fluid located above the blade unit 110 toward the accommodating part 111, thereby allowing the washer fluid to be sufficiently heated and then discharged to the outside of the blade unit 110 after being melted.

In an embodiment, the second blade part 113 may include third blades 1131 that are connected to the accommodating part 111 and disposed to be spaced apart from each other. In an embodiment, the third blades 1131 may be disposed to be spaced apart from each other at equal intervals in one direction (x-direction).

The third blades 1131 may be connected to the accommodating part 111. One side of each of the third blades 1131 may be directly coupled to the accommodating part 111, and another side thereof may extend in a direction toward the outer edge of the blade unit 110. For example, as illustrated in FIG. 4, the third blades 1131 may each have an elongated rectangular shape extending in the longitudinal direction of the blade unit 110 (y-direction).

In an embodiment, as shown in FIG. 4, the third blades 1131 may not be formed as a single elongated rectangular shape, but may include rectangular unit elements. In other words, unlike the first blade 1121, which defines a space between the second blades 1122, the third blades 1131 may have a structure in which a plurality of unit elements are arranged in a row to increase a contact area with the washer fluid w placed below the blade unit 110.

One of the third blades 1131 may be disposed on the same plane as the first blade 1121. The other third blades 1131 may be symmetrically disposed with respect to the third blade 1131 that is disposed on the same plane as the first blade 1121.

In an embodiment, the blade unit 110 may further include auxiliary blades 1061 and 1062 extending from opposite sides of the accommodating part 111. The auxiliary blades 1061 and 1062 may serve to allow the washer fluid liquefied by heat of the accommodating part 111 to be stably placed at the lower portion of the washer fluid reservoir 11.

In an embodiment, the blade unit 110 may include the connection part 114, at one side of which one side of each of the first blade part 112, the accommodating part 111, and the second blade part 113 is connected to each other, and which is coupled to the body unit 120.

In an embodiment, the blade unit 110 may include a protruding part 115 that protrudes from another side of the connection part 114 and is fitted into the body unit 120. The protruding part 115 may be in communication with the connection part 114 and the accommodating part 111. Through this, the heater 100 may be inserted into the accommodating part 111 via the protruding part 115. Although not shown in the drawings, the protruding part 115 may include one or more sealing members (not shown) disposed along an outer circumferential surface of the protruding part 115 to prevent the washer fluid w from penetrating into the heater 100.

In an embodiment, the body unit 120 may be coupled to one side of the blade unit 110. Referring again to FIG. 2, the body unit 120 may serve to fix the blade unit 110 to the washer fluid reservoir 11. An insertion groove 121 into which the protruding part 115 of the blade unit 110 is inserted and fixed may be provided in the body unit 120.

The sealing unit 130 may serve to seal between the heater module 10 and the washer fluid reservoir 11 when the body unit 120 is coupled to the washer fluid reservoir 11.

According to an embodiment of the present disclosure, when the heater module 10 having the above-described structure is coupled to the washer fluid reservoir 11, the first blade part 112 may be disposed on an upper side with respect to the direction of gravity and the second blade part 113 may be disposed on a lower side with respect to the direction of gravity. Through this, the washer fluid w, which is frozen and located at an upper portion (p1, see FIG. 2) of the washer fluid reservoir 11 may be liquefied by the heater 100, guided along the first blade part 112, and then located at a lower portion (p2, see FIG. 2) of the washer fluid reservoir 11. In this case, since the washer pump 12 is located adjacent to the lower portion of the washer fluid reservoir 11, the heater module 10 may efficiently guide the washer fluid w to the washer pump.

The present disclosure has been described above in relation to its preferred embodiments. It will be understood by those skilled in the art that various changes in form and details may be made therein without departing from the essential features of the present disclosure. Therefore, the disclosed embodiments should be considered in descriptive sense only and not for purposes of limitation. The scope of the present disclosure is defined not by the detailed description of the disclosure but by the appended claims, and all differences within the scope will be construed as being included in the present disclosure.

According to the above-described problem-solving means of the present disclosure, a blade unit and a heater module including the same, according to embodiments of the present disclosure, can heat washer fluid in a washer fluid reservoir and efficiently supply the washer fluid to the washer pump disposed below the washer fluid reservoir.

What is claimed is:

1. A heater module comprising
a heater;
a blade unit including an accommodating part configured to accommodate the heater therein, a first blade part disposed at one side of the accommodating part, and a second blade part disposed at another side of the accommodating part; and
a body unit coupled to one side of the blade unit,
wherein the first blade part and the second blade part have different blade structures.

2. The heater module of claim 1, wherein the first blade part includes:
a first blade connected to the accommodating part; and
a pair of second blades symmetrically disposed with respect to the first blade.

3. The heater module of claim 2, wherein the pair of second blades are not directly connected to the accommodating part.

4. The heater module of claim 2, wherein each of the pair of second blades includes a second-1 sub-blade, a second-2 sub-blade, and a second-3 sub-blade that extend in different directions from each other.

5. The heater module of claim 4, wherein
the second-1 sub-blade extends in a same direction as a direction in which the first blade extends, and
the second-2 sub-blade and the second-3 sub-blade extend in directions different from the direction in which the first blade extends.

6. The heater module of claim 4, wherein an angle between the second-1 sub-blade and the second-2 sub-blade is smaller than an angle between the second-1 sub-blade and the second-3 sub-blade.

7. The heater module of claim 4, wherein an angle between the first blade and the second-2 sub-blade is greater than an angle between the first blade and the second-3 sub-blade.

8. The heater module of claim 1, wherein the second blade part includes third blades that are connected to the accommodating part and are disposed to be spaced apart from each other.

9. The heater module of claim 8, wherein the third blades are disposed to be spaced apart from each other at equal intervals.

10. The heater module of claim 8, wherein one of the third blades is disposed on a same plane as the first blade.

11. The heater module of claim 1, wherein the blade unit further includes a connection part configured to connect one side of each of the first blade part, the accommodating part, and the second blade part to each other and to be coupled to the body unit.

12. The heater module of claim 1, further comprising a sealing unit disposed at one side of the body unit.

13. A washer fluid supply apparatus comprising:
a washer fluid reservoir;
a heater module disposed in the washer fluid reservoir; and
a washer pump connected to one side of the washer fluid reservoir,
wherein the heater module includes:
a heater;
a blade unit including an accommodating part configured to accommodate the heater therein, a first blade part disposed at one side of the accommodating part, and a second blade part disposed at another side of the accommodating part; and
a body unit coupled to one side of the blade unit,
wherein the first blade part and the second blade part have different blade structures.

14. The washer fluid supply apparatus of claim 13, wherein
the first blade part is disposed on an upper side with respect to a direction of gravity in the washer fluid reservoir, and
the second blade part is disposed on a lower side with respect to the direction of gravity in the washer fluid reservoir.

15. A blade unit comprising:
an accommodating part configured to accommodate a heater therein;
a first blade part disposed on one side of the accommodating part; and
a second blade part disposed on another side of the accommodating part.

16. The blade unit of claim 15, wherein the first blade part includes:
a first blade connected to the accommodating part; and
a pair of second blades symmetrically disposed with respect to the first blade.

17. The blade unit of claim 16, wherein each of the pair of second blades includes a second-1 sub-blade, a second-2 sub-blade, and a second-3 sub-blade that extend in different directions from each other.

18. The blade unit of claim 17, wherein
the second-1 sub-blade extends in a same direction as a direction in which the first blade extends, and
the second-2 sub-blade and the second-3 sub-blade extend in directions different from the direction in which the first blade extends.

19. The blade unit of claim 17, wherein an angle between the second-1 sub-blade and the second-2 sub-blade is smaller than an angle between the second-1 sub-blade and the second-3 sub-blade.

20. The blade unit of claim 17, wherein an angle between the first blade and the second-2 sub-blade is greater than an angle between the first blade and the second-3 sub-blade.
